(19) United States
(12) Patent Application Publication
(10) Pub. No.: US 2017/0316722 A1
(43) Pub. Date: Nov. 2, 2017

(54) LIGHT-EMITTING SIGNBOARD

(71) Applicant: Ledyoung Technology Corporation, Taoyuan City (TW)

(72) Inventor: Yen-Chou HSU, Taoyuan City (TW)

(21) Appl. No.: 15/143,618

(22) Filed: May 1, 2016

(51) Int. Cl. G09F 13/22; G09F 9/00

(52) U.S. Cl. CPC G09F 13/22; G09F 9/00; G09F 2013/222

(57) ABSTRACT

A combination signboard having the characteristics of low cost, ease of fabrication, maintenance and replacement is disclosed to include a signboard body having multiple through holes, multiple display devices detachably mounted on the signboard body, each display device including a mount having a recessed portion and multiple countersunk holes located in the recessed portion, a light guide plate positioned in the recessed portion, a light source module sandwiched between the light guide plate and the recessed portion and connection members made in the form of a screw bolt and respectively mounted in the countersunk holes of the mount, and locking members made in the form of a screw nut and respectively threaded onto the screw bolt-shaped connection members to detachably lock the display devices to the signboard body.

### BACKGROUND OF THE INVENTION

### 1. Field of the Invention

The present invention relates to signboard technology and more particularly, to a combination signboard, which comprises a signboard body and a plurality of display devices detachably mounted in the signboard, having the characteristics of low cost, ease of fabrication, maintenance and replacement.

### 2. Description of the Related Art

Light-emitting signboards are widely used for advertisement, road sign and escape indication applications. Regular light-emitting signboards commonly comprise a light guide plate, a LED-based light source configured to emit light into the light guide plate, and light diffusing components mounted in the light guide plate and configured to refract and diffuse light toward the outside of the light guide plate. The use of a light guide plate in a light-emitting signboard has various advantages; however, it also brings the following problems.

(A) A large size signboard needs to use a large size light guide plate. It is difficult to make a large size light guide plate and to print a design on a large size light guide plate, resulting in high product cost.

(B) When a large size light guide plate is used, a relatively larger amount of light sources should be installed so that the light guide plate can provide sufficient brightness, and the problem of uneven brightness can occur, obstructing the sense of beauty of the display design, further, it will be very inconvenient to detach the signboard for maintainance in case any light source fails.

(C) If the pattern or text is loosely presented on surface of the light guide plate, it will cause unnecessary waste of the surface area of the light guide plate, increasing costs. When wishing to change a part of the pattern or text, it is necessary to change the whole light guide plate, causing waste.

### SUMMARY OF THE INVENTION

The present invention has been accomplished under the circumstances in view. It is therefore the main object of the present invention to provide a combination signboard, which is formed by detachably mounting multiple display devics on a signboard body, wherein each display device consists of a light guide plate, a mount and a light source module, and thus, if the light guide plate or light source module of one display device fails, the respective display device can be detached from the signboard body for repair.

It is another object of the present invention to provide a combination signboard, which is formed by detachably mounting multiple display devics on a signboard body, minimizing the size of light guide plates and facilitating the fabrication of light guide plates.

To achieve these and other objects of the present invention, a combination signboard comprises a signboard body, a plurality of display devices, and a plurality of locking members. The signboard body comprises a base panel. The base panel has a plurality of through holes cut through opposing front and back walls thereof. The display devices are detachably mountable on the front wall of the signboard body. Each display device comprises a mount, a light guide plate, at least one connection member and a light source module. The mount comprises a recessed portion. The light guide plate is positioned in the recessed portion. The light source module is positioned between the light guide plate and the recessed portion of the mount. Each connection member is mounted in the mount and extended out of the mount opposite to the recessed portion. The locking members are respectively attached to the back wall of the signboard body and fastened to the connection members of the display devices to lock the display devices to the signboard body in a detachable manner.

### BRIEF DESCRIPTION OF THE DRAWINGS

FIG. 1 is a schematic front view of a combination signboard in accordance with a first embodiment of the present invention.

FIG. 2 is a sectional view of a part of the combination signboard in accordance with the first embodiment of the present invention.

FIG. 3 is an oblique front elevational view of one display device of the combination signboard in accordance with the first embodiment of the present invention.

FIG. 4 is an oblique rear elevational view of the display device shown in FIG. 3.

FIG. 5 is a sectional side view of one display device of the combination signboard in accordance with the first embodiment of the present invention.

FIG. 6 is an exploded view of one display device of the combination signboard in accordance with the first embodiment of the present invention.

FIG. 7 is a sectional side view of a combination signboard in accordance with a second embodiment of the present invention.

FIG. 8 is an oblique front elevational view of the combination signboard in accordance with the second embodiment of the present invention.

FIG. 9 is an oblique rear elevational view of the combination signboard in accordance with the second embodiment of the present invention.

FIG. 10 is a sectional view of the display device of the combination signboard in accordance with the second embodiment of the present invention.

### DETAILED DESCRIPTION OF THE PREFERRED EMBODIMENT

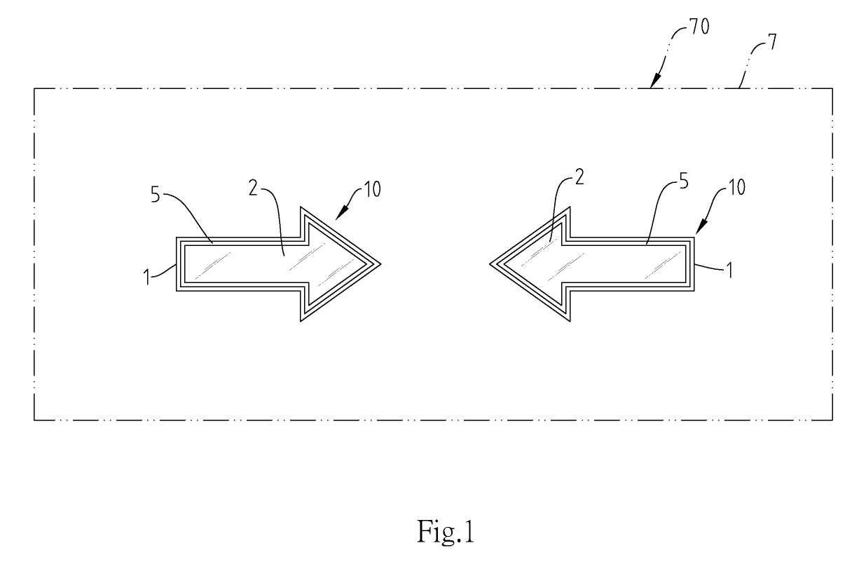

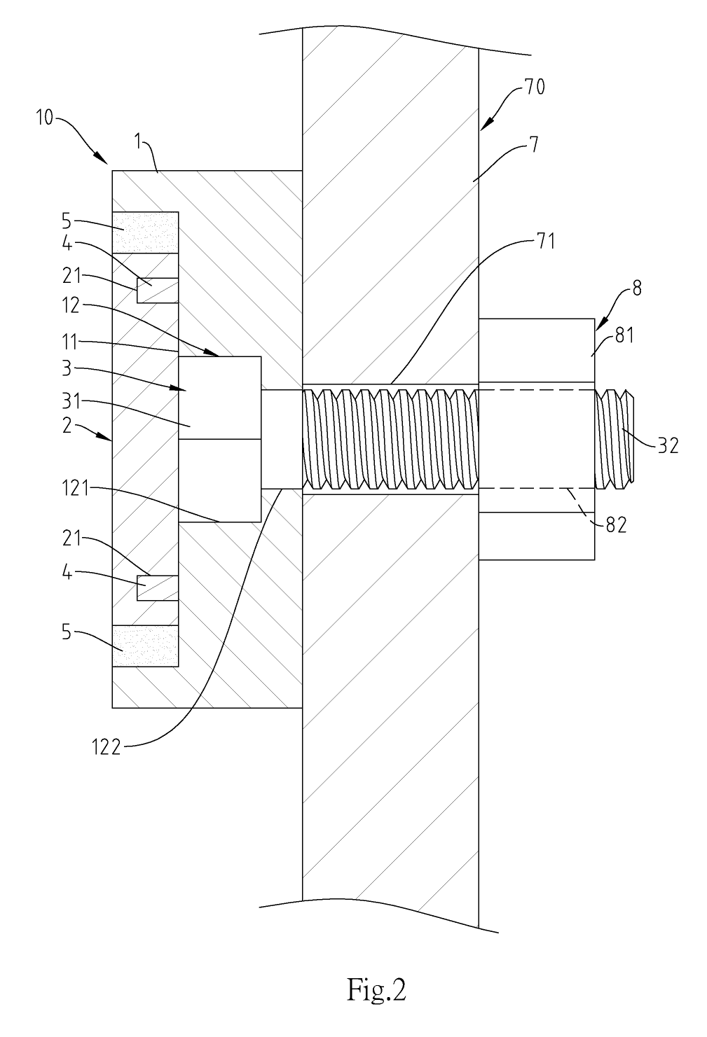

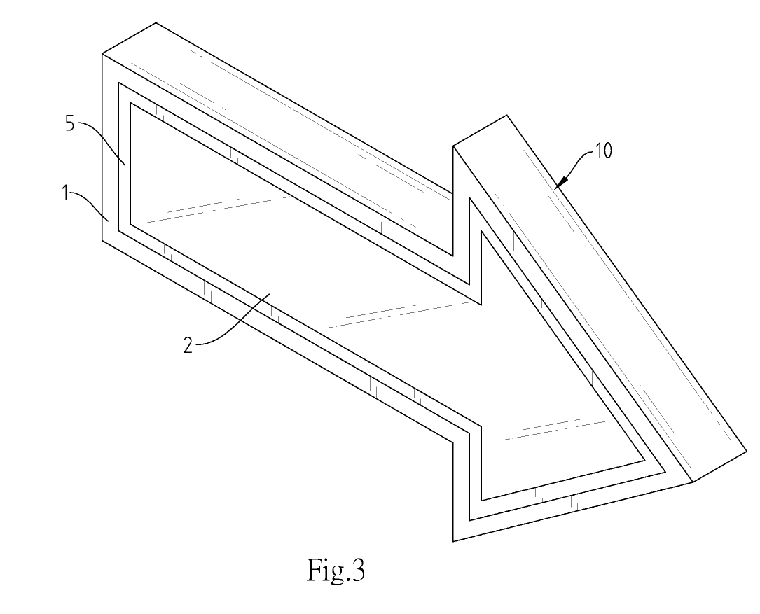

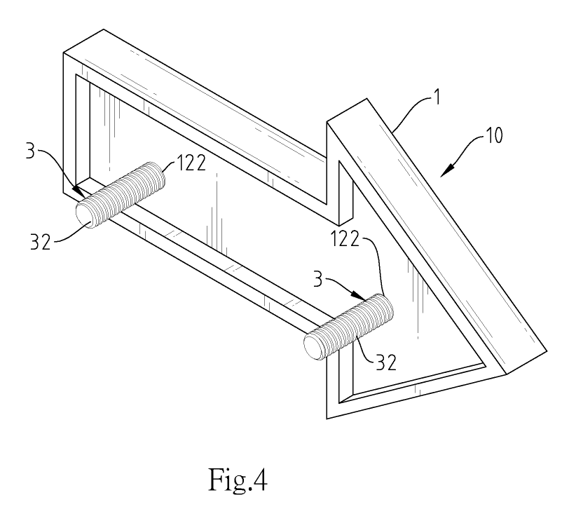

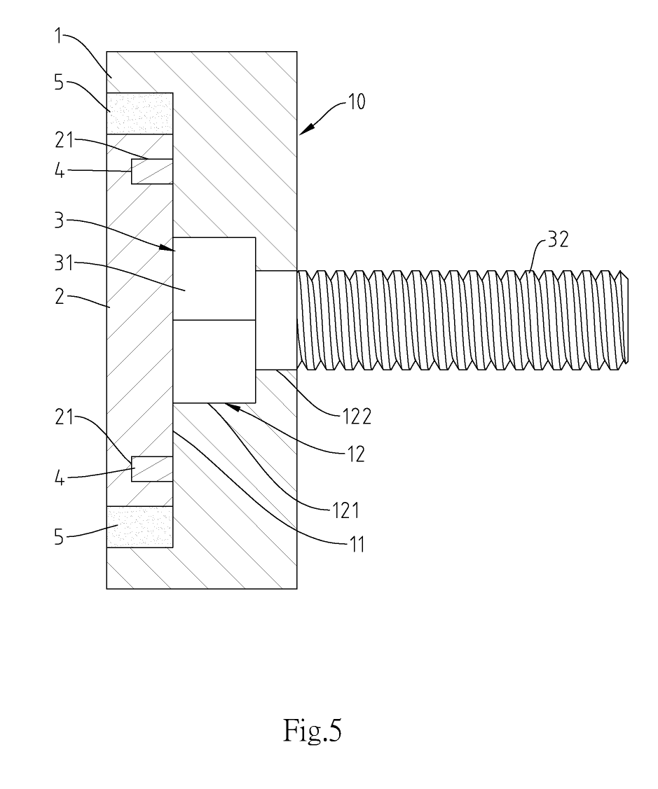

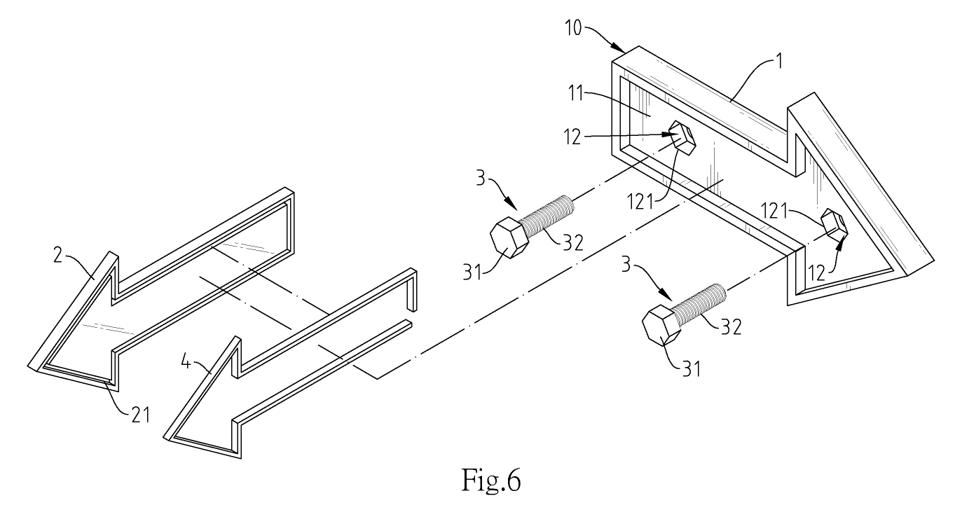

Referring to FIGS. 1-6, a combination signboard in accordance with a first embodiment of the present invention is shown. The combination signboard comprises a plurality of display devices 10 and a signboard body 70.

Each display device 10 comprises a mount 1, a light guide plate 2, at least one, for example, two connection members 3, and a light source module 4. The mount 1 comprises a recessed portion 11 located in a front wall thereof in a predetermined shape, and at least one, for example, two mounting holes 12 located in the recessed portion 11 and cut through an opposing back wall thereof. Each mounting hole 12 comprises a position-limit hole portion 121 abutted to the recessed portion 11, and a through hole portion 122 extended from one side of the position-limit hole portion 121 remote from recessed portion 11 and cut through the back wall of the mount 1. Further, the inner diameter of the position-limit hole portion 121 is greater than the inner diameter of the through hole portion 122. The ight guide plate 2 is positioned in the recessed portion 11. Further, an adhesive 5 is applied to the peripheral edges of the light guide plate 2 and the surface of the recessed portion 11 of the mount 1 to bond the light guide plate 2 to the recessed portion 11. The light guide plate 2 defines an accommodation open chamber 21 in a bottom side thereof. The light source module 4 is accommodated in the accommodation open chamber 21 of the light guide plate 2. Thus, after installation of the display device 10, the light source module 4 firmly held between the light guide plate 2 and the recessed portion 11 of the mount 1. Further, the light source module 4 in this embodiment is a LED light bar. Further, each connection member 3 comprises a positioning head 31, and a threaded shank 32 perpendicularly extended from the center of a bottom wall of the positioning head 31. The positioning head 31 is positioned in the position-limit hole portion 121 of one mounting hole 12 of the mount 1, enabling the threaded shank 32 to extend through the through hole portion 122 in direction away from the recessed portion 11 to the outside of the mount 1.

The signboard body 70 comprises a base panel 7 and a plurality of locking members 8. The base panel 7 has a plurality of through holes 71. The locking member 8 comprises a locking member body 81, and an inner thread 82 defined in the locking member body 81.

When mounting each display device 10 in the signboard body 70, place the mount 1 of the display device 10 on the base panel 7 to aim the connection members 3 at the respective through holes 71 of the base panel 7 and then to force the threaded shanks 32 of the respective connection members 3 through the respective through holes 71 of the base panel 7, and then thread the inner threads 82 of the respective locking members 8 onto the threaded shanks 32 of the respective connection members 3 to lock the mount 1 to the base panel 7.

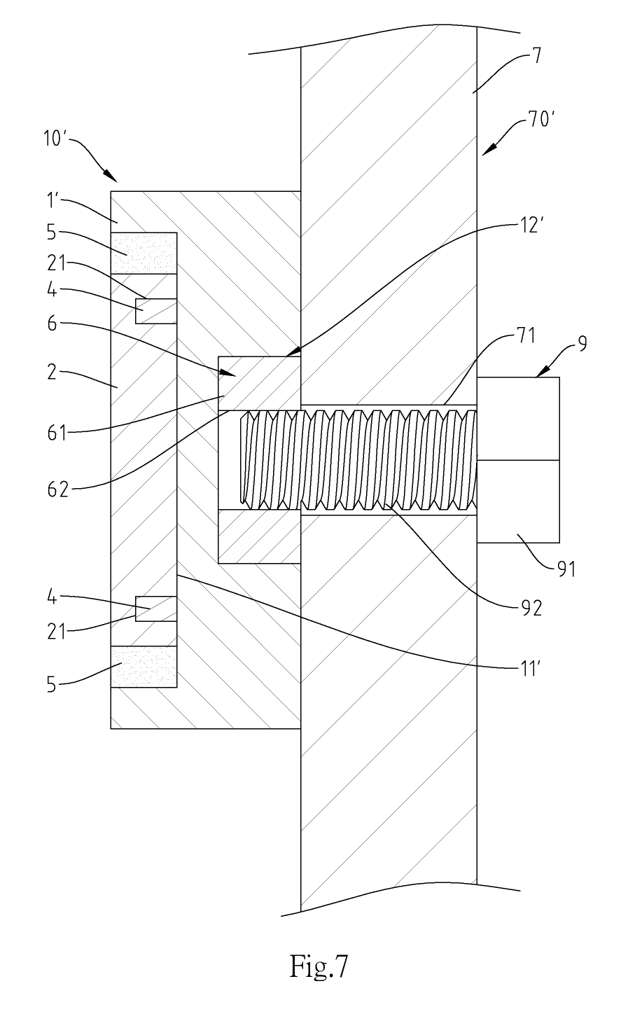

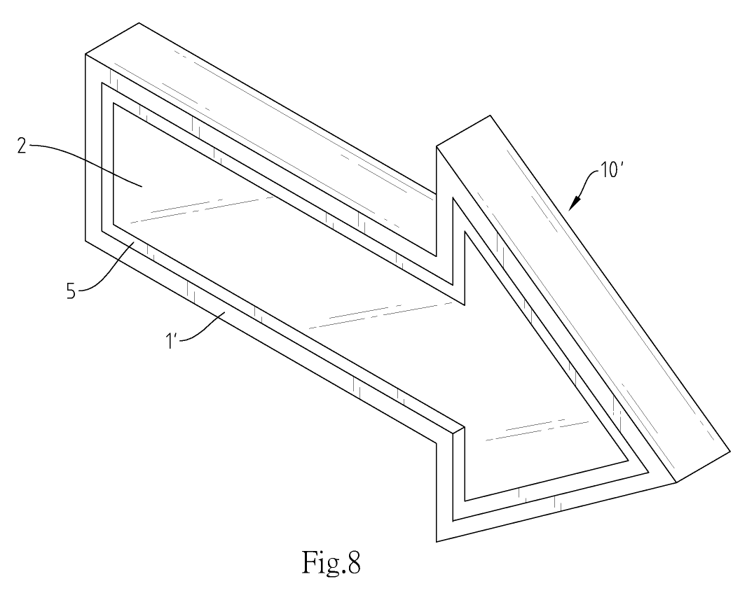

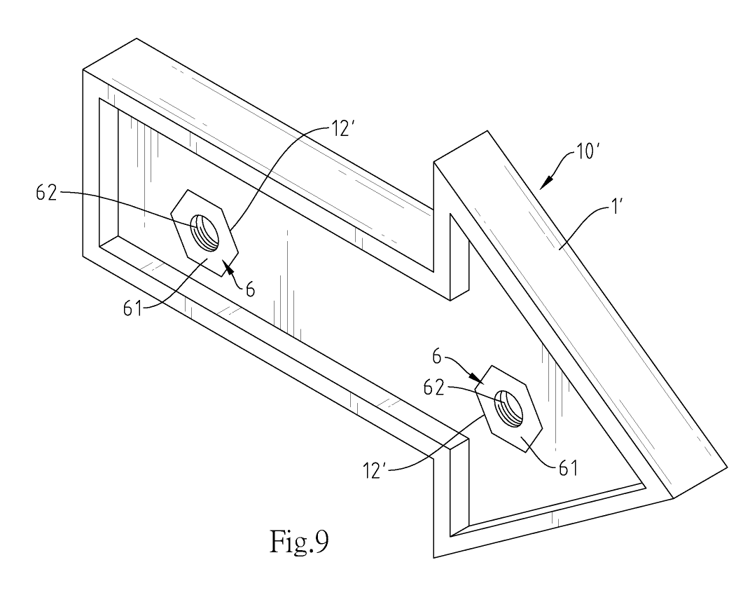

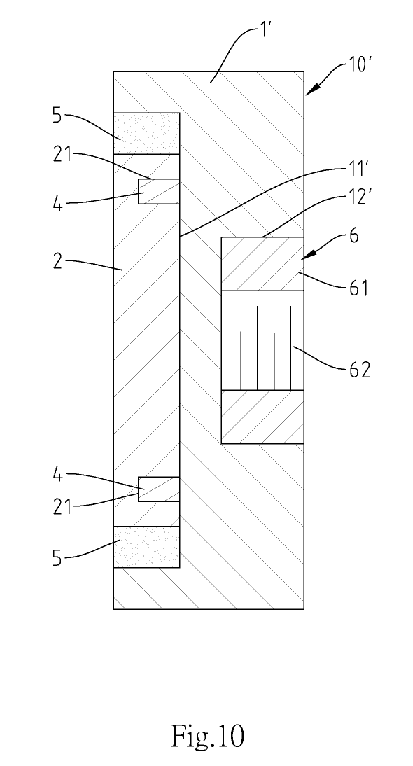

Referring to FIGS. 7-10, a combination signboard in accordance with a second embodiment of the present invention is shown. This second embodiment is substantially similar to the aforesaid first embodiment with the exception that the mount 1′ of the display device 10′ further comprises a plurality of locating holes 12′ located on the back wall thereof opposite to the recessed portion 11′; each connection member 6 of each display device 10′ comprises a connection member body 61 positioned in one res[ectove mounting hole 12′, and an inner thread 62 defined in the connection member body 61; each locking member 9 of the signboard body 70′ comprises a positioning head 91 stopped at a back wall of the signboard body 70′, and a threaded shank 92 extended from the positioning head 91 and inserted through one respective through hole 71 of the base panel 7 and then threaded into the inner thread 62 of the connection member 6 to lock the display device 10′ to the signboard body 70′.

What the invention claimed is:

1. A combination signboard, comprising:
a signboard body comprising a base panel, said base panel having a plurality of through holes cut through opposing front and back walls thereof;
a plurality of display devices detachably mountable on the front wall of said signboard body, each said display device comprising a mount, a light guide plate, at least one connection member and a light source module, said mount comprising a recessed portion, said light guide plate being positioned in said recessed portion, said light source module being positioned between said light guide plate and said recessed portion of said mount, each said connection member being mounted in said mount and extended out of said mount opposite to said recessed portion;
and a plurality of locking members respectively attached to the back wall of said signboard body and fastened to said connection members of said display devices to lock said display devices to said signboard body.

2. The combination signboard as claimed in claim 1, further comprising an adhesive bonded between peripheral edges of each said light guide plate and the surface of said recessed portion of said mount.

3. The combination signboard as claimed in claim 1, wherein said mount of each said display device comprises at least one mounting hole located in the recessed portion thereof, each said mounting hole comprising a position-limit hole portion abutted to the associating said recessed portion and a through hole portion extended from said position-limit hole portion in direction away from the associating said recessed portion, the inner diameter of said position-limit hole portion being greater than the inner diameter of said through hole portion; each said connection member comprises a positioning head positioned in said position-limit hole portion of one respective said mounting hole, and a threaded shank extended from said positioning head and inserted through said through hole portion of the respective said mounting hole; each said locking member comprises a locking member body, and an inner thread defined in said locking member body and threaded onto said threaded shank of one respective said connection member.

4. The combination signboard as claimed in claim 1, wherein said mount of each said display device comprises at least one locating hole located in a back wall thereof opposite to the associating said recessed portion; each said connection member comprises a connection member body positioned in one respective said locating hole, and an inner thread defined in said connection member body; each said locking member comprises a positioning head stopped at a back wall of said base panel of said signboard body, and a threaded shank extended from the positioning head and inserted through one respective said through hole of the base panel and then threaded into said inner thread of one respective said connection member to lock the respective said display device to said signboard body.
